(19) United States
(12) Patent Application Publication
(10) Pub. No.: US 2011/0246952 A1
(43) Pub. Date: Oct. 6, 2011

(54) ELECTRONIC DEVICE CAPABLE OF DEFINING TOUCH GESTURES AND METHOD THEREOF

(75) Inventor: ER-KAI TSAO, Tu-Cheng (TW)

(73) Assignee: HON HAI PRECISION INDUSTRY CO., LTD., Tu-Cheng (TW)

(21) Appl. No.: 12/894,179

(22) Filed: Sep. 30, 2010

(30) Foreign Application Priority Data
Mar. 31, 2010 (CN) 201010137130.1

(51) Int. Cl. G06F 3/033

(52) U.S. Cl. 715/863

(57) ABSTRACT

An electronic device capable of defining touch gesture is provided. The electronic device includes a touch panel, a touch detection circuit, a processing unit, and a storage unit. The touch detection circuit produces touch signals in response to user touch operation on the touch panel. The processing unit includes a gesture recognition module and a defining module. The gesture recognition module receives the touch signals from the touch detection circuit, and recognizes touch gesture according to the touch signals. The defining module controls the electronic device to enter a defining module in response to user operation, and prompts the user to define a touch gesture for a function of the electronic device, and establish a map between the touch gesture input by the user and the function selected by the user, and store the map in the storage unit.

### BACKGROUND

1. Technical Field

The present disclosure relates to electronic devices and, particularly, to an electronic device capable of defining touch gestures, and a method for the device.

2. Description of Related Art

Nowadays, electronic devices with touch input functions are very popular. People can control the electronic device by using touch gestures, such as tap, double tap, and flick quickly and conveniently. However, people can only execute a function by using a predetermined touch gesture set by the producer. For example, usually, people can unlock the electronic device only by moving the finger from left to right but cannot unlock the electronic device by using other touch gestures.

Therefore, it is desirable to provide an electronic device with touch input functions to overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device capable of defining touch gestures in accordance with an exemplary embodiment.

FIG. 2 is a flowchart illustrating a method for defining touch gestures implemented by the electronic device of FIG. 1.

FIG. 3 is a flowchart illustrating a process of operating the electronic device of FIG. 1 in accordance with an exemplary embodiment.

### DETAILED DESCRIPTION

Embodiments of the present disclosure will now be described in detail below, with reference to the accompanying drawings.

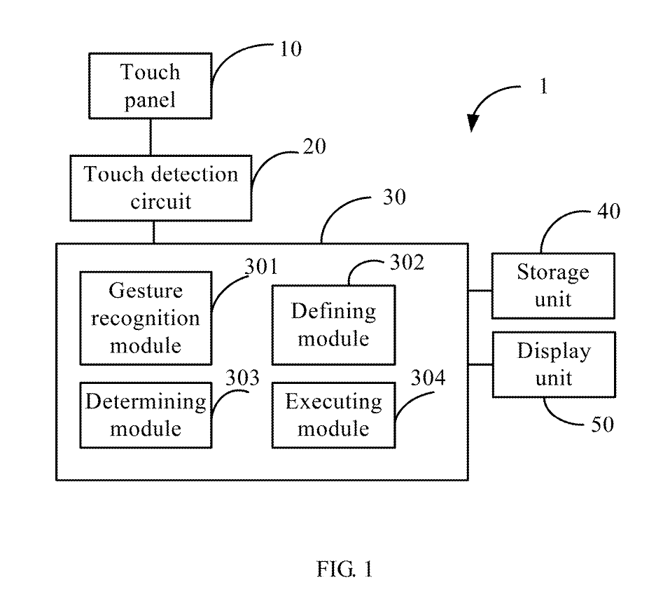

Referring to FIG. 1, an electronic device 1 capable of defining touch gestures (hereinafter “the electronic device 1”) includes a touch panel 10, a touch detection circuit 20, a processing unit 30, a storage unit 40, and a display unit 50. The electronic device 1 is capable of recognizing a touch gesture and executing a function associated with the recognized touch gesture, and is also capable of defining a new touch gesture for the function if need.

The touch panel 10 can be a single-point touch panel or a multi-point touch panel. In one embodiment, the touch panel 10 combines with the display unit 50 to form a touch screen. The touch detection circuit 20 produces touch signals in response to touches on the touch panel 10.

The processing unit 30 includes a gesture recognition module 301 and a defining module 302. The gesture recognition module 301 receives touch signals from the touch detection circuit 20 and recognizes a touch gesture according to the touch signals.

The defining module 302 controls the electronic device 1 to enter a defining mode in response to a defining operation from the user, and prompts the user to define a touch gesture for a function of the electronic device 1 in the defining mode. For example, the defining module 302 controls the display unit 50 to display the functions of the electronic device 1 for selection, prompts the user to define the touch gesture for a selected function, and stores the defined touch gesture associated with the function in the storage unit 40. In more detail, when a function of unlocking the electronic device 1 (hereinafter, “the unlock function”) is selected, the defining module 302 prompts the user to define the touch gesture for the unlock function, the user can input the touch gesture corresponding to the unlock function discretionary. The gesture detection module 301 determines the touch gesture input by the user according to the touch signals. The defining module 302 establishes a map between the recognized touch gesture input by the user and the selected function, and stores the map between the recognized touch gesture and the selected function to the storage unit 40. In one embodiment, the electronic device 1 provides a menu including a menu item for defining touch gestures. In another embodiment, the electronic device 1 provides a predetermined button for defining touch gestures. In a further embodiments, the electronic device 1 provides a combination of the menu and the predetermined button.

The processing unit 30 further includes a determining module 303 and an executing module 304. The defining module 302 is further configured to control the electronic device 1 to switch from the defining mode to a normal mode when receiving an operation of finishing defining touch gestures. In the normal mode, when the user touches the touch panel 10, the touch detection circuit 20 produces the touch signals in response to the touch operation. The gesture recognition module 301 determines the touch gesture according to the touch signals. The determining module 303 determines the function corresponding to the touch gesture according to the map between the touch gesture and the function. The executing module 304 executes the function.

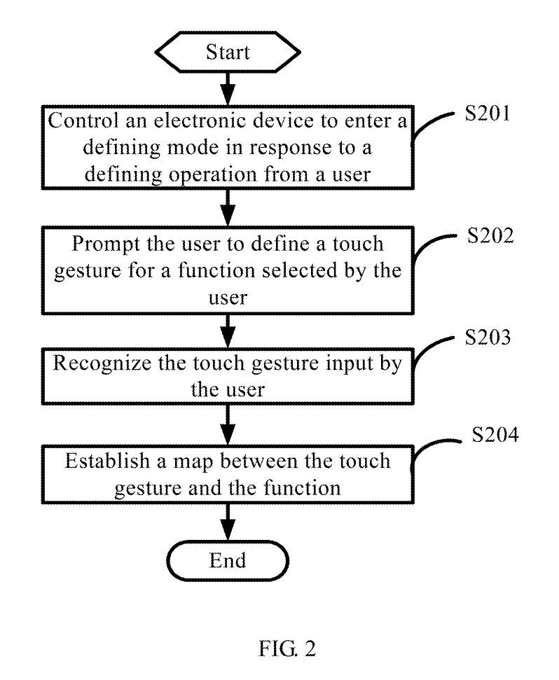

FIG. 2 is a flowchart illustrating a method for defining touch gesture implemented by an electronic device in accordance with an exemplary embodiment.

In step S201, the defining module 302 controls the electronic device to enter a defining mode in response to a defining operation from a user.

In step S202, the defining module 302 prompts the user to define a touch gesture for a function selected by the user.

In step S203, the gesture recognition module 301 recognizes the touch gesture input by the user.

In step S204, the defining module 302 establishes a map between the touch gesture and the function, and stores the map between the touch gesture and the function to the storage unit 40.

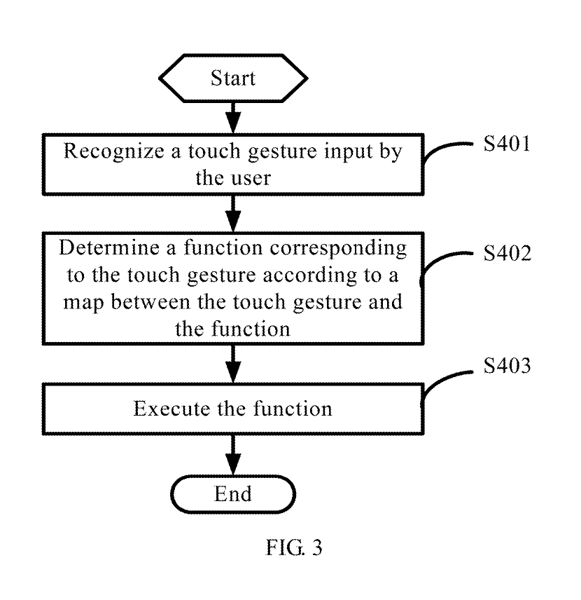

FIG. 3 is a flowchart illustrating a process of operating an electronic device in accordance with an exemplary embodiment.

In step S401, the gesture recognition module 301 recognizes touch gesture input by the user.

In step S402, the determining module 303 determines the function corresponding to the touch gesture according to the map between the touch gesture and the function stored in the storage unit 40.

In step S403, the executing module 304 executes the function.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch panel;
a storage unit;
a touch detection circuit, configured to produce touch signals in response to touches on the touch panel; and
a processing unit, comprising:
a gesture recognition module, configured to receive the touch signals from the touch detection circuit, and recognize a touch gesture according to the touch signals; and
a defining module, configured to control the electronic device to enter a defining mode in response to a defining operation from the user, and prompt the user to define a touch gesture for a function of the electronic device, and establish a map between the touch gesture input by the user and the function selected by the user, and store the map between the touch gesture and the function in the storage unit.

2. The electronic device according to claim 1, wherein the electronic device further comprises a display unit, the defining module is further configured to control the display unit to display functions of the electronic device for selection.

3. The electronic device according to claim 1, wherein the defining module is further configured to control the electronic device to switch from the defining mode to a normal mode when receiving an operation of finishing defining touch gestures.

4. The electronic device according to claim 3, further comprising:
a determining module, configured to determine the function corresponding to a touch gesture input by user according to the map between the touch gesture and the function stored in the storage unit, when the electronic device is in the normal module; and
an executing module, configured to execute the function.

5. A method for defining touch gesture, applied in an electronic device, the electronic device including a storage unit, the method comprising:
controlling the electronic device to enter a defining mode in response to a defining operation from a user;
prompting the user to defining touch gesture for a function selected by the user;
recognizing the touch gesture input by the user; and
establishing a map between the touch gesture and the function and storing the map between the touch gesture and the function into the storage unit.

6. The method according to claim 5, further comprising:
switching from the defining mode to a normal mode when receiving an operation of finishing defining touch gestures.

7. The method according to claim 6, further comprising:
recognizing a touch gesture input by the user;
determining a function corresponding to the touch gesture according to the map between the touch gesture and the function stored in the storage unit; and
executing the function.
